(19) United States
(12) Patent Application Publication
(10) Pub. No.: US 2026/0071988 A1
(43) Pub. Date: Mar. 12, 2026

(54) GREASE BUILDUP SENSOR

(71) Applicant: LEXMARK INTERNATIONAL, INC., LEXINGTON, KY (US)

(72) Inventors: KEITH BRYAN HARDIN, LEXINGTON, KY (US); ROBERT HENRY MUYSKENS, LEXINGTON, KY (US); JOHN FRANCIS GOSTOMSKI, RICHMOND, KY (US)

(21) Appl. No.: 19/324,004

(22) Filed: Sep. 9, 2025

Related U.S. Application Data
(60) Provisional application No. 63/692,541, filed on Sep. 9, 2024.

(51) Int. Cl. G01N 27/04; F24C 15/20

(52) U.S. Cl. CPC G01N 27/04; F24C 15/20

(57) ABSTRACT

A device for determining an aggregate amount of grease along a predetermined line or path along the hood and/or duct of a ventilation system. This is done by having a conductor above a ground plane with a pulse stimulus. The pulse travels along the conductor and the velocity signal are determined by the materials that the electromagnetic waves are traveling through. When grease builds up around the conductor and toward the ground plane, the dielectric of the grease slows the signal velocity down which is detected and measured. This is compared to the expected velocity when the grease is not there. Time limit thresholds are used to determine the amount of grease along the conductor path that indicates when cleaning is suggested or required.

### CROSS REFERENCES TO RELATED APPLICATIONS

None.

### BACKGROUND

### 1. Field of the Disclosure

The present disclosure relates generally to cooking ventilation systems and more particularly to a sensing mechanism for detecting grease buildup in a cooking ventilation system.

### 2. Description of the Related Art

In commercial kitchens and food preparation environments, ventilation systems are commonly employed to manage airborne byproducts generated during cooking processes, particularly those involving fryers. These systems typically utilize vent hoods to extract oil vapors, steam, and other volatile compounds from the cooking area. The primary objectives of such ventilation are to reduce human exposure to potentially harmful substances and to mitigate fire hazards associated with the accumulation of flammable vapors.

However, the temperature differential between the hot vapors and the cooler surfaces of the ventilation system often results in condensation. This condensation forms a residue composed of water and congealed cooking oils, commonly referred to as grease. Over time, grease accumulates on the interior surfaces of the ventilation ducts and hoods, presenting a significant fire risk due to its flammability.

Currently, the industry relies on manual inspection methods to assess the depth of grease buildup. These measurements serve as indicators for determining when a cleaning cycle should be initiated. Manual monitoring, however, is labor-intensive, prone to human error, and may not provide timely alerts, thereby increasing the risk of fire and reducing operational efficiency.

### SUMMARY

The present disclosure provides a novel technique for determining grease depth along a predetermined line or path along the hood and/or duct of a ventilation system. This is done by having a conductor above a ground plane with a pulse stimulus. The pulse travels along the conductor and the velocity signal are determined by the materials that the electromagnetic waves are traveling through. When grease builds up around the conductor and toward the ground plane, the dielectric of the grease slows the signal velocity down which is detected and measured. This is compared to the expected velocity when the grease is not there. Time limit thresholds are used to determine the amount of grease along the conductor path that indicates when cleaning is suggested or required.

The present disclosure gives a cumulative grease indication that can be used to validate when cleaning actions are needed. Other embodiments include those wherein the location of the grease along the conductor can be found by looking at the reflection of the signal. This can be used to determine if the cleaning is needed along the entire conductor length or spot locations.

### BRIEF DESCRIPTION OF THE DRAWINGS

The accompanying drawings incorporated in and forming a part of the specification, illustrate several aspects of the present disclosure, and together with the description serve to explain the principles of the present disclosure.

FIG. 1 illustrates a kitchen cooking station having a ventilation system and a grease sensing assembly according to one example embodiment.

FIGS. 2A and 2B are diagrammatic top and side views, respectively, of the grease sensing assembly in FIG. 1 according to one example embodiment.

FIG. 3 shows the grease sensing assembly in FIG. 2B with grease buildup.

FIG. 4 illustrates a conductor of the grease sensing assembly above a conducting surface according to one example embodiment.

FIG. 5 illustrates a test fixture having a test wire at a predetermined height above a test conducting surface according to one example embodiment.

FIG. 6 is graph showing a Time Domain Reflectometer (TDR) signal from a signal source into the test wire in FIG. 5 with the test fixture having no grease.

FIG. 7 is a graph showing a time delay between signals measured at opposite ends of the test wire in FIG. 5 with the test fixture having no grease.

FIG. 8 illustrates the test fixture in FIG. 5 having grease.

FIG. 9 is graph showing a TDR signal from the signal source into the test wire in FIG. 8 with the test fixture having grease.

FIG. 10 is a graph showing a time delay between signals measured at opposite ends of the test wire in FIG. 8 with the test fixture having grease.

FIG. 11 is a diagram illustrating a pulse delay source and measurement circuit according to one example embodiment.

FIG. 12 illustrates an operational state diagram with timing diagram according to one example embodiment.

FIGS. 13A-13C show example ridged brackets to mount the grease sensing assembly on.

FIG. 14 illustrates a grease sensing assembly having a differential pair of conductor wires above a conducting surface according to one example embodiment.

### DETAILED DESCRIPTION

In the following description, reference is made to the accompanying drawings where like numerals represent like elements. The embodiments are described in sufficient detail to enable those skilled in the art to practice the present disclosure. It is to be understood that other embodiments may be utilized and that process, electrical, and mechanical changes, etc., may be made without departing from the scope of the present disclosure. Examples merely typify possible variations. Portions and features of some embodiments may be included in or substituted for those of others. The following description, therefore, is not to be taken in a limiting sense and the scope of the present disclosure is defined only by the appended claims and their equivalents.

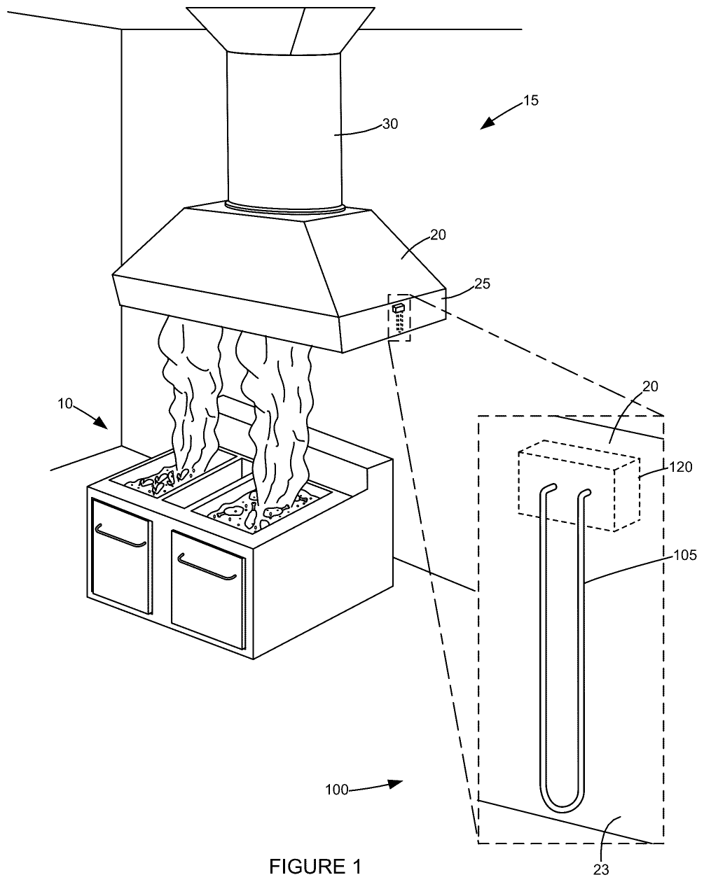

FIG. 1 illustrates an example of a kitchen cooking station 10 equipped with a ventilation system 15. Ventilation system 15 includes an overhead vent hood 20 configured to capture and direct oil-laden steam and airborne particulates generated during cooking operations. These vapors are conveyed through one or more ducts 30 that terminate either at the rooftop or along an exterior wall for exhaust.

In one example embodiment, the ventilation system 15 includes a grease sensing assembly 100 configured to monitor the accumulation of grease film within the ventilation system 15. In the embodiment illustrated, the grease sensing assembly 100 includes a sensing element 105 positioned along an interior wall 23 of the hood 20 and an electronics module 120 disposed at an exterior wall 25 of the hood 20. The sensing element 105 is configured to detect the presence and thickness of grease deposits based on dielectric properties of materials, such as fat, oil, and grease, building up in the sensing element 105. The electronics module 120 is configured to analyze signals from the sensing element 105 and determine when cleaning or maintenance is required to enhance fire safety and ensure compliance with ventilation hygiene standards.

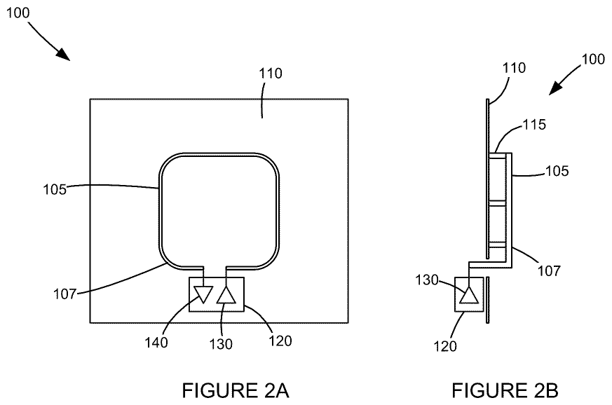

FIGS. 2A and 2B are top and side diagrammatic views, respectively, of the grease sensing assembly 100 with no grease according to one example embodiment. In the embodiment shown, the sensing element 105 of the grease sensing assembly 100 includes a conductor 107 spaced a predetermined height or distance from a ground plane or conducting surface 110. In one example, the conducting surface 110 can be a portion of the hood or duct wall. In another example, the ground plane can be another metal surface mounted to the duct wall. The conductor 107 is held at the predetermined height by insulating posts or tabs 115 to keep the conductor 107 at the desired height above the conducting surface 110.

In this embodiment, an electrical signal is used along the conductor 107 to determine an aggregate amount of grease along the conductor and a depth of the grease. This is done by leveraging the known, predetermined length of the conductor that the signal travels across. A signal source 130 is placed at one end of the conductor 107, while a receiver 140 is placed at the opposite end of the conductor 107. As the signal propagates from the source 130 to the receiver 140, a timer circuit is used to measure the time between transmission (when the signal source 130 sends the signal) and reception (when the signal arrives at the receiver 140). Variations in signal travel time caused by the presence and characteristics of the grease are used to infer the quantity and depth of grease along the conductor. In one embodiment, the signal source 130 is an electronic output that applies a step voltage with a predetermined rise time to the conducting wire or trace. The signal travels around the loop to the receiver 140. The delay from the source 130 to the receiver 140 is determined by the length (distance) of the conducting wire and the velocity of the signal. This delay T_{0delay} is equal to distance/V₀.

The side view in FIG. 2B shows that the signal source 130 is located outside of the hood 20 while the conductor 107 is positioned inside the hood 20, and that the signal can be sent through the conducting surface 110 (which is the hood 20 in this example) via an opening in the conducting surface. The signal then propagates through the conductor 107 parallel to the conducting surface 107 until the signal reaches the receiver 140 at the opposite end of the conductor. The advantage of the source and receiver electronics being on the outside of the vent hood duct is that the environment is not as hot or harsh compared to the inside of the duct. The duct interior is subjected to hot and humid air with oils, grease, and cleaners. Grease solvents with scraping and bushing are used to clean the ducts when needed. By having the signal conductor start and terminate near the same location, the source signal can be close to the receiver. This means that additional system delays are minimized, and the source reference time is a short distance to the reference receiver.

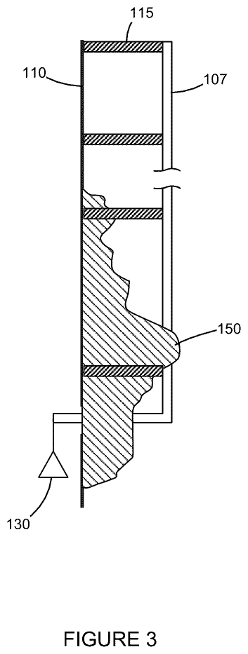

During use of the cooking station 10, grease will start to build up on the cooler surfaces when the oils and fats condense, causing the build-up of grease. FIG. 3 shows the grease sensing assembly 100 with grease 150 starting to build up on the conducting surface 110 between the conductive signal paths. The dielectric spacers or tabs 115 keep the conductor 107 at the desired height above the conducting surface 110. The oils and fats are nonconductive dielectrics which will modify the electric field intensities but not the magnetic field intensities. As the oils and grease build up, the time for the signal to propagate from the source to the receiver will increase. This is because the propagation speed of the signal is inversely proportional to the square root of the effective dielectric constant such that a higher dielectric constant slows down the signal while a lower dielectric constant allows the signal to travel faster. For example, the relative dielectric constant (εᵣ) of grease is approximately 3 such that the signal speed can drop by √3≈1.733 resulting in about 73% increase in delay time for the signal to arrive from the source to the receiver if the fields travel mostly within the grease. The delay will be proportional to the amount of grease the field travels through. If, for example, the grease is only half the distance along the wire then the delay may decrease by 73%/2=36.5%.

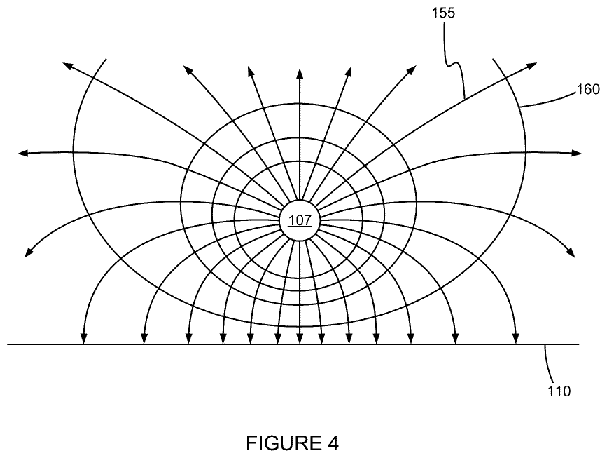

FIG. 4 shows the conductor 107 running above the conducting surface 110 or ground plane. When a signal travels through the conductor 107, it creates the electric field lines 155 and the magnetic field lines 160 that spread into the space between the conductor 107 and the conducting surface 110, and into the air or any material above the conductor 107. Note the closeness of the electric field lines that radiate from the center conductor with the plus sign to the ground plane on the bottom. This area of closeness is due to the negative charge on the surface of the conducting surface 110 that is attracted to the positive charge on the conductor 107. As the grease starts to build up, the higher percentage of the field lines in the grease will effectively slow down the propagation of the signal along the conductor 107. The grease will generally be uniformly distributed along the conducting surface 110 with some additional concentration under and around the wire. There is a grease meniscus that will tend to form due to the wire. Gravity will also affect the distribution of the grease.

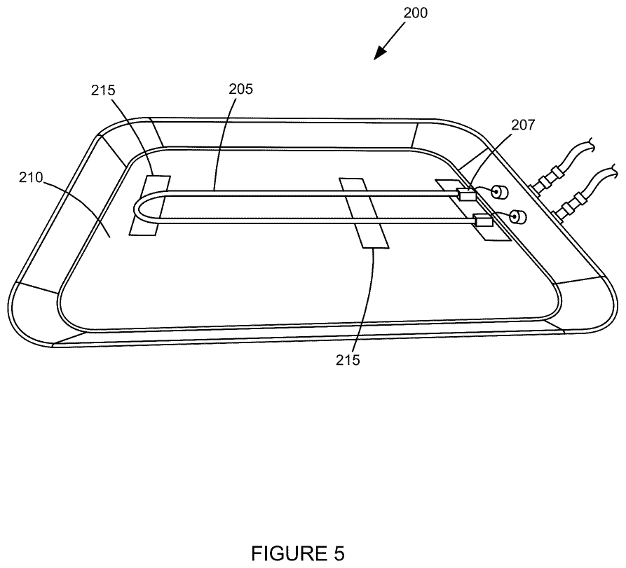

FIG. 5 shows an example test fixture 200 having a test wire 205 used as the conductor sensing element 105 at a predetermined height above a test conducting surface 210 used as the ground plane. Plastic film strips 215 are formed and placed under the test wire 205 to give the desired height of the wire from the ground plane. The medium that the electromagnetic fields are traveling through determines the velocity of propagation. In this experiment, a voltage source signal is used to create voltage step (or trapezoidal) rise to a transmission line. For example, using the setup in FIG. 5, a Time Domain Reflectometer (TDR) was used as a signal source to create a step source rise time at the input end 207 of the test wire 205. A peak or upward step in the TDR signal suggests a higher impedance (e.g., an open circuit or dielectric with lower εᵣ) while a valley or downward step in the TDR signal suggests a lower impedance (e.g., a short circuit or dielectric with higher εᵣ such as grease.) An oscilloscope was used to measure the source and receiver signal delay.

The signal propagates at the speed of light V₀ in air (approximately 2.99×10⁸ meters/second). V₀ in air is determined by the permittivity and permeability which is ε₀=8.85418782×10⁻¹² m⁻³ kg⁻¹ s⁴ A² and μ₀=1.25663706×10⁻⁶ m kg s⁻² A⁻² respectively. Generally, the velocity is calculated as V=1/\sqrt{ε*μ}. The permittivity and permeability can be thought of in relative terms as ε=¿ε₀*εᵣ and μ=¿μ₀*μᵣ where the r subscript denotes the relative value.

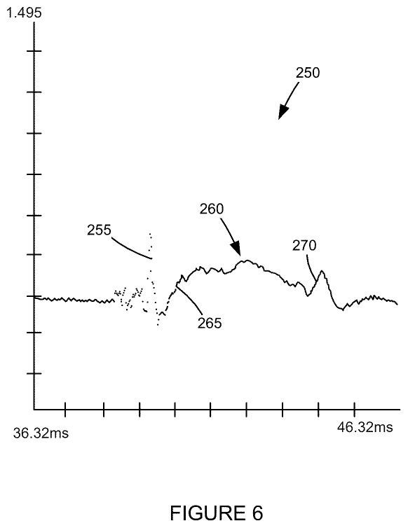

FIG. 6 shows a graph 250 of the TDR signal from the signal source into the test wire 205 with the setup having no grease. The horizontal axis represents time which correlates to distance along the signal line while the vertical axis represents the magnitude of signal reflections caused by changes in impedance along the line. In the graph, the initial flat horizontal line is the time spent in the 50-ohm cables used to get the TDR signal to the test fixture. The first upward impulse 255 is where the signal reaches the wire that connects the coaxial cable connector to the test wire. The relatively flat signal portion 260 between the second upward impulse 265 and the third upward impulse 270 corresponds to the portion where TDR signal is travelling through the test wire 205 above the ground plane influenced by the impedance of the test wire.

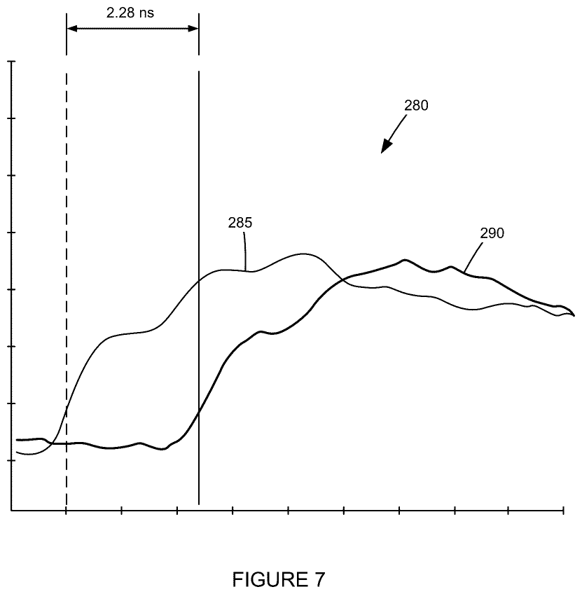

FIG. 7 shows a graph 280 from an oscilloscope showing a first signal 285 measured at the signal source and a second signal 290 measured at the receiver. In the example shown, the time between the source rise and the receiver rise is approximately 2.28 ns. In this example, the approximate length of the signal conductor is 60 cm which results in a calculated time delay of 0.60 meters/(2.99×10⁸ meters/second)=2 ns.

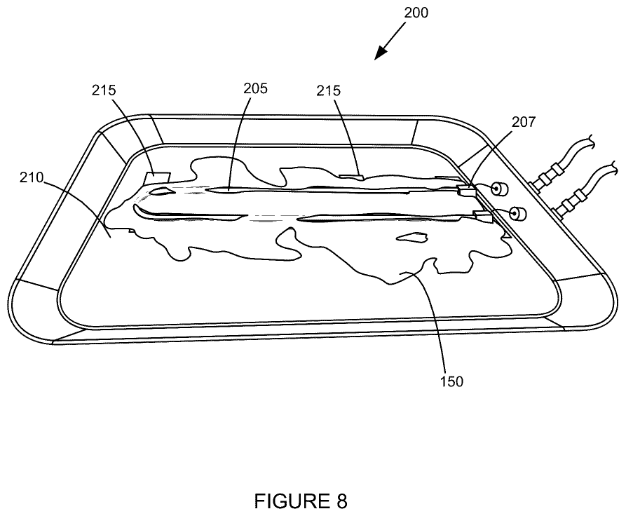

To determine the effect of grease on the TDR signal, oil was applied to the surface conducting ground plane and then heated and cooled. The oil is airiated to make it soft in the initial state. The air in the oil causes the dielectric constant to be lower than when heated and cooled. The heat liquified the oil allowing the air to escape, and then cooling the grease allowed the grease to solidify again. FIG. 8 shows the test fixture 200 having grease 150 that has solidified after heating and cooling.

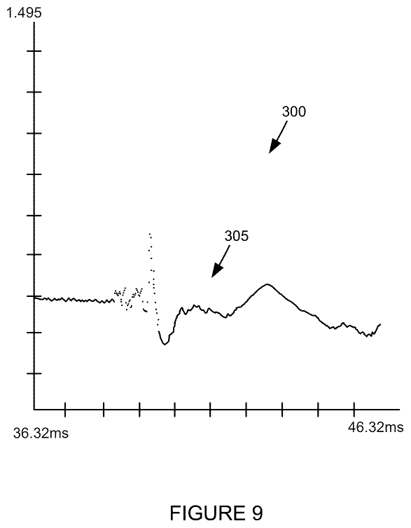

FIG. 9 shows a graph 300 of the TDR signal from the signal source 130 into the test wire 205 with the setup having grease. The presence of grease increases the effective dielectric constant of the line which, in turn, lowers the characteristic impedance of the line. In the example shown, the portion 305 where the TDR signal is travelling through the test wire 205 with grease has a lower amplitude in comparison to the portion 260 of the TDR signal shown in FIG. 7 (without grease) due to the lower impedance along the test wire 205 caused by the grease 150.

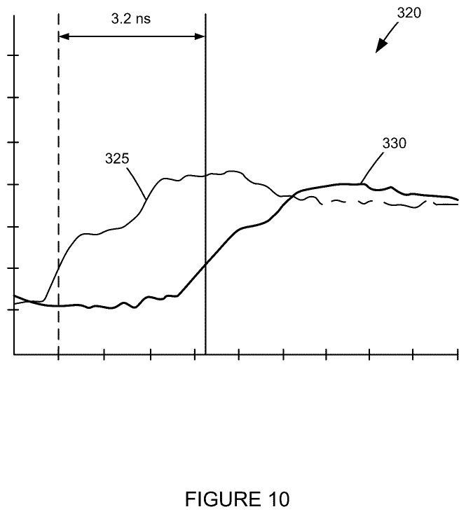

FIG. 10 shows a graph 320 from an oscilloscope showing a first signal 325 measured at the signal source 130 and a second signal 330 measured at the receiver 140 with the test wire 205 having grease. As shown, the time delay between the source rise and the receiver rise has increased to 3.2 ns. The calculated delay for a relative dielectric constant εᵣ=3 is 3.5 ns assuming that all of the fields are in the dielectric material. In this example, the grease only touches the conducting test wire so the resulting velocity is a bit faster, reducing the measured delay time.

The measured time delay is compared to an expected signal time delay when no grease is present. Based on this comparison, an estimate of the quantity and/or depth of grease deposit may be determined. In the above example embodiment, time delays or time limit thresholds are used to determine the amount of grease along the conductor path. Experimental data may be used to calibrate the expected delay to set the threshold limit to indicate grease build up limits.

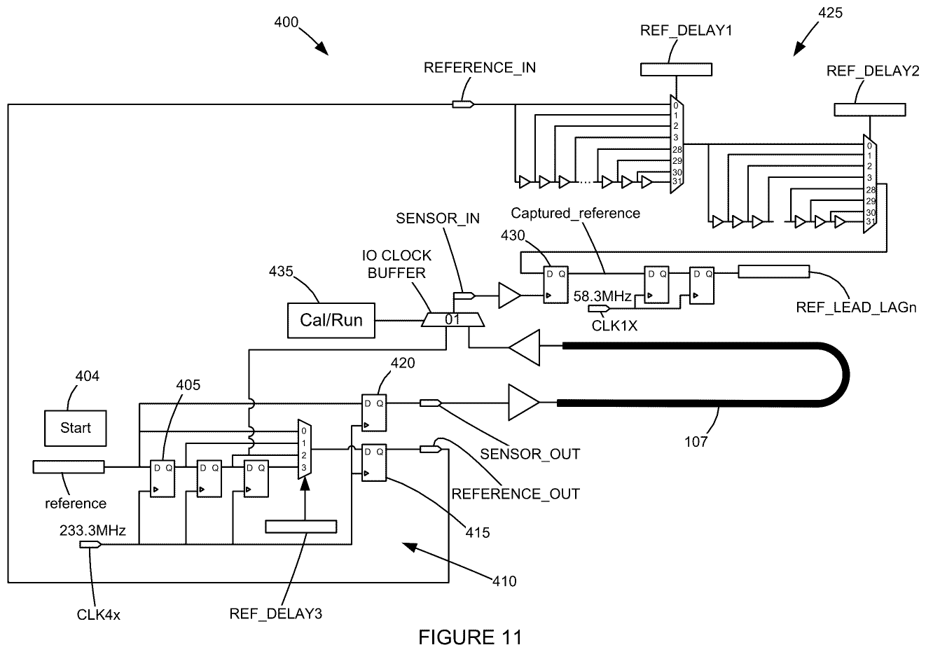

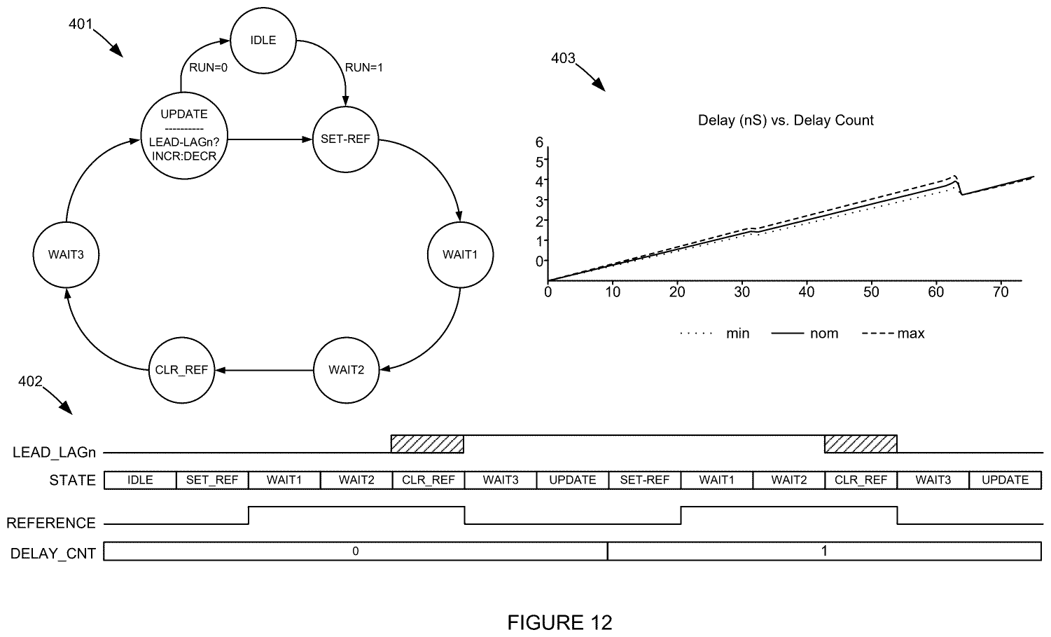

In another example embodiment, a Field Programmable Field Array (FPGA), an Application Specific Integrated Circuit (ASIC) or discrete logic circuit with a calibrated delay chain may be used to measure the time delay between the source and receiver. FIG. 11 shows an example pulse delay source and measurement circuit 400. FIG. 12 shows an example operational state diagram 401 with a timing diagram 402 and delay chart 403. The logic process for the design includes a start signal 404 that initiates an edge. For this example, all edges of significance are rising edges. However, one skilled in the art would recognize that either edges for rising or falling may be used. The start signal is also called the reference. The start signal initiates a measurement. The REFERENCE signal goes to a D flipflop 405 that is clocked by a signal called CLK4X (233.3 MHz for this example). The output of this D flipflop is used to drive the signal into the grease sensing conductor wire 107. The REFERENCE signal is also sent to a programmable delay block 410 that can send the signal to the REFERENCE_OUT D flipflop 415 at approximately the same time as to the SENSOR_OUT D flipflop 420 or delayed by 1, 2 or 3 CLK4 times depending on the REF_DELAY3 setting. If the total sensor delay time is greater than the CLK4X clock time, then REF_DELAY3 is used to delay the REFERENCE_OUT signal. This allows for a measurement capability much longer than the REF_DELAY1 and REF_DELAY2 could normally handle. The REF_DELAY3 block may be replaced by a counter that could extend the SENSOR_OUT to REFERENCE_OUT to any arbitrary number of clocks.

The REFERENCE_OUT signal is fed into the two tandem 32 delay buffers 425 to delay this signal by predetermined amounts with the input designated as REFERENCE_IN. The illustrated design has 62 delay buffers of fixed amounts. The illustrated design has a delay of 78 pS per buffer. The maximum delay is equal to 78 pS*62=4,836 pS. In this example, the delay is longer than the period of the CLK4X clock of 4286 pS which provides the ability to calibrate the average delay time by comparing to the clock time. The delay blocks are presented to the D input of a flipflop 430. This flipflop is clocked by the SENSOR_IN signal that is either from the grease sensor conductor 107 or by the reference signal delayed by one CLK4X clock period SENSOR_OUT.

During the Run measurement cycle, the SENSOR_OUT signal is driven into the grease sensor conductor 107. The signal travels along the sensor wire through the Cal/Run multiplexer 135 to clock the D flipflop that received the delay signal block output.

The operation process is determined by initially setting the REF_DELAY1 and REF_DELAY2 values to be expected to be a time less than the delay along the grease sensor conductor path. The REF_DELAY3 is set to 0 if the expected grease sensor conductor delay is less than the total REF_DELAY1 and REF_DELAY2 times. If the grease sensor conductor delay is expected to be greater than a CLK4X clock period but less than 2×CLK4X clock periods, then the REF_DELAY3 is set to 1. The REF_DELAY3 is incremented for each additional CLK4X clock period that the grease sensor conductor delay is expected to be the number of CLK4X clock periods longer in time.

When the system is set up for a measurement, a “Start” is sent that launches a signal along the grease sensor conductor path and the REF_DELAY1 and REF_DELAY2 paths. If the reference signal arrives at the D flipflop before the SENSOR_IN signal clock input, then the output of the “captured reference” D flipflop Q will be high. This will happen if the initial guess setting for the REF_DELAY1 and REF_DELAY2 are less than the grease sensor delay. For this case, the REF_DELAY1 and REF_DELAY2 are increased and started again. This repeats until the “captured reference” is found to be low. The REF_DELAY1 and REF_DELAY2 can then be decreased until the “captured reference” is high again. The REF_DELAY1 and REF_DELAY2 are iterated up and down until the delay time is found that is just at the edge of the “captured reference” transition. This delay represents the measured propagation time through the grease sensor conductor 107.

The grease sensor conductor delay measurement is made during the initial installation to determine the expected delay when the ducts are clean and without grease. The measurement is made repeatedly during operation. The delay measurement increases proportionally to the increasing grease depth along the sensor conductor. In one example, a threshold may be set so that an initial clean cycle is indicated when the depth is approximately 0.078 inches deep. A critical clean condition may be initiated when the grease depth is greater than 0.125 inches deep.

In this example, the REFERENCE signal (START) is generated by a state machine using a signal called CLK1X that is 58.333 MHz. After setting the REFERENCE signal, the state machine must wait for all propagation and clock synchronization delays to complete before checking whether the delayed REFERENCE_IN signal arrives before (leads) or after (lags) the SENSOR_IN signal. In this example, the rising edge of the SENSOR_IN signal was used to capture the state of the delayed REFERENCE_IN signal. In this case, when REF_LEAD_LAGn is set, it indicates that the delayed REFERENCE_IN signal arrived before the SENSOR_IN signal and the state machine will increase the delay count. Likewise, when REF_LEAD_LAGn is clear, it indicates that the delayed REFERENCE_IN signal arrived after the SENSOR_IN signal and the state machine will decrease the delay count. Eventually, the delay count settles when the delayed REFERENCE_IN signal arrives at the same time as the SENSOR_IN signal.

The delay count is then applied to REF_DELAY1 (0 to 31 delay buffers), REF_DELAY2 (31 to 62 delay buffers) and REF_DELAY3 (0 to 3 CLK4X period delays). The logic and resulting delays are shown in FIG. 12. In the example shown, the delay is not a linear function of delay count. When increasing from the maximum delay chain to a CLK4x cycle, the CLK4X period was selected to be less than the full delay chain time. As a result, there is a decrease in delay time when the delay count is a multiple of 64. Also, when increasing from the end of the first delay chain (REF_DELAY1) to the start of the second delay chain (REF_DELAY2), the resulting delay time is the same. For example, when the delay count is 31, REF_DELAY1 is 31 and REF_DELAY2 is not used (0). When the delay count is 32, REF_DELAY1 is fixed at 31 and REF_DELAY2 is modulo 32 of the delay count (0).

In another example embodiment, the REF_DELAY1 and REF_DELAY2 times may be calibrated against the CLK4X time period by “Cal/Run” function by setting the multiplexer to the 0 path. The same process is used to find the REF_DELAY1 and REF_DELAY2 time that is the delay that is equal to the clock period. If the CLK4X period is 1/(233×10⁶)=4.286 nS, then a 78 pS delay element would mean that the edge would be found between 54 and 55 delay elements. This is found by dividing the delay element time into the clock period (4.286 nS/78 pS=54.95). The time delay of each delay element may be variable on the operating conditions of the part used to measure the time. Crystal based clock systems have the least variations due to these conditions. By measuring the clock period, many of these operation conditions can be compensated for a more accurate measurement.

The sensor orientation and height above the reference conductor is very important for the operation and cleaning of the sensor. The ducts may not have a flat surface to run the grease sensor conductor along the surface. In one example embodiment, cable clamps may be used to mount to a bracket to keep the sensor wire at the predetermined height above the bracket. For example, a strain relief clip may be used to hold the grease sensor conductor in place at the correct height above the conductive surface.

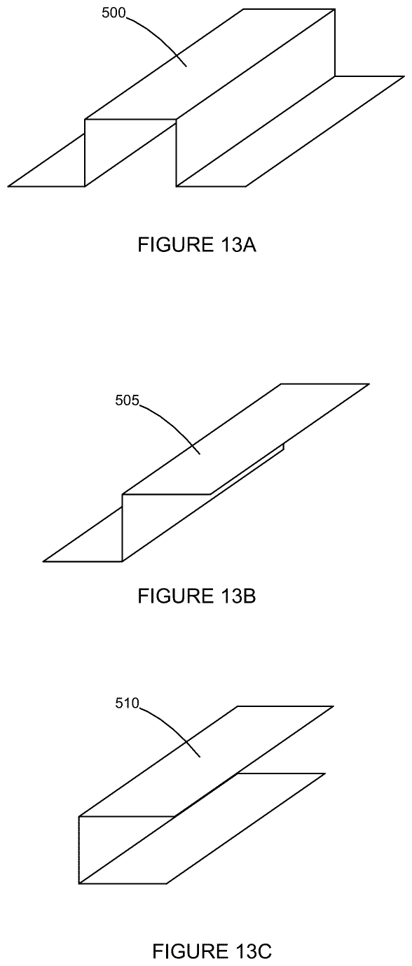

FIGS. 13A-13C show examples of ridged brackets to mount the grease sensor assembly on. FIG. 13A shows a hat channel profile 500 that may be used to mount the grease conductor sensor that remains straight and ridged. The bracket may be mounted in any direction that facilitates the accurate buildup and cleaning of the duct system. The hat channel can also be substituted with a Z channel 505 shown in FIG. 13B or C channel cross section 510 shown in FIG. 13C. This exposes both vert sides to cleaning agents so that grease build up will not be retained in the interior of the hat cross section.

In one example embodiment, the sensor may be mounted vertically such that the U-shaped grease sensor conductor 107 has the source and receiver ends up in the duct. This allows the grease and cleaner to pull down to the bottom of the U-shaped conductor and drip off.

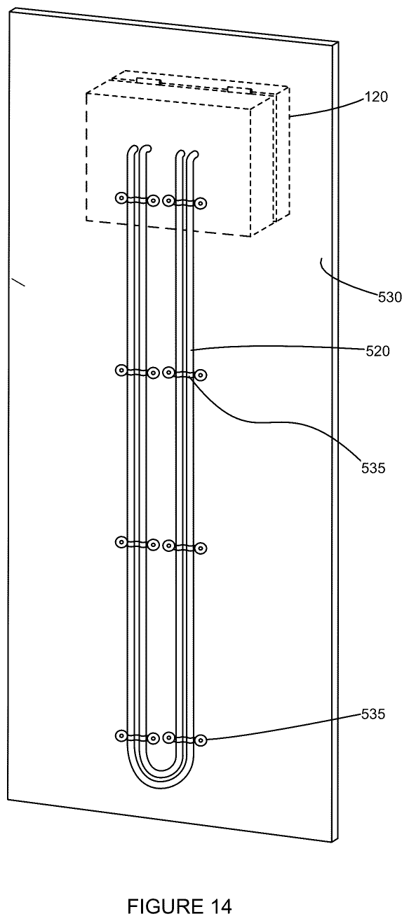

FIG. 14 shows a grease sensor assembly having a differential pair of conductor wires 520 above a conducting surface 530 according to another example embodiment. This configuration emphasizes the grease build up between the pair of conductor wires 520 as opposed to the grease between the signal wires and the returning conductive surface 530. The driving method can be single ended or differential. The receiver can be single ended, differential or cross coupled. Shown are spacers 535 that hold the separation between the conductor wires and the conducting surface.

In another example embodiment, the signal may be sampled at the output buffer feeding the grease conductor sensor. This allows the reflected analog signal to be measured. In this example, the sensor out buffer source impedance is set to a value that is approximately equal to the average of the transmission line impedance when it is grease-free and when the grease depth indicates that cleaning is required. The sampling of this signal can be a high speed sampler or a single shot sampler with a programmable delay that is run repeatedly to trace out the reflection over time. This is the mechanism that lets the circuit perform the time domain reflectometry as shown in FIGS. 5 and 8. The reflected signals are used to indicate where the grease buildup is along the line. In this design, the buffer input from the grease sensor conductor has an input impedance that is a similar output of the buffer impedance that is driving the grease conductor sensor.

All of these configurations and sensing architectures may be used to determine several key responses. In the event that the signal time-delay is sufficient to imply excessive grease buildup, one or multiple actions may be performed. In one example, a technician is automatically notified via an internet connected device that a specific hood vent or location is in need of cleaning or inspection. In another example, a technician could be automatically scheduled for a future visit which is predicted to be when the hood needs cleaning. This could be any number of days beyond the point that the time delay response implies cleaning will be soon required. In another example, an automated cleaning cycle can be executed (one or multiple times). This cleaning process may involve a liquid misting device capable of distributing cleaning chemicals onto the surface of the grease and ductwork which assists in cleaning the duct walls and enabling grease to drip down through cleaning drain paths. Repeated cleaning cycles can be run based on the continued response of the sensing device. In another example, a secondary camera may capture an image based on the level of grease detected by the sensor and transmit the image back to a remote service technician, or for the generation of an automated report.

In order to support a best case, or worst case, measurement scenario, the sensing conductors may be placed far away from the cleaning mist sprayer, or in close proximity to the cleaning mist sprayer. A special purpose mister may be installed in immediate proximity above the sense conductors to ensure that the sensors receive sufficient chemical to clean between the duct (or ground plane) and sensor conductors. The conductors may be oriented vertically to allow gravity to assist the chemical cleaning agent in draining the grease buildup between the conductor and ground plane. The sensing conductors and ground plane assembly may be designed such that they can be easily removed from a slot in the ductwork, making a manual inspection, replacement, or cleaning of the sensor possible.

The foregoing description illustrates various aspects and examples of the present disclosure. It is not intended to be exhaustive. Rather, it is chosen to illustrate the principles of the present disclosure and its practical application to enable one of ordinary skill in the art to utilize the present disclosure, including its various modifications that naturally follow. All modifications and variations are contemplated within the scope of the present disclosure as determined by the appended claims. Relatively apparent modifications include combining one or more features of various embodiments with features of other embodiments.

1. A device for determining an aggregate amount of grease along a conductor at a predetermined height over a conducting surface comprising:
a predetermined length of a conductor on which a source signal is transmitted;
a source placed at one end of the conductor;
a receiver placed at the opposite end of the conductor; and
a timer circuit to measure the time between when the source sends the signal and when the signal arrives at the receiver.

2. A method of measuring an aggregate amount of grease along a conductor at a predetermined height over a conducting surface comprising:
initiating setting a first reference delay value and a second reference delay value to a time less than the delay along the grease sensor conductor path;
setting a third reference delay value to zero if the expected grease sensor conductor delay is less than the total first reference delay value and second reference delay value time;
setting the third reference delay to 1 if the grease sensor conductor delay is expected to be greater than a first clock period but less than twice the first clock period, where the third reference delay is incremented higher for each additional clock period that the grease sensor conductor delay is expected to be the number of clock periods longer in time; and
initiating a launch of a signal along the grease sensor conductor path and the first reference delay value and second reference delay value paths,
wherein if the reference signal arrives before a signal clock input then the output of the capture reference will be high, and the first reference delay value and second reference delay values are increased for another iteration.

3. A device for detecting an amount of grease deposit in a cooking exhaust vent, comprising:
a conductor having a first end and a second end, where each end is configured for positioning outside a cooking exhaust vent;
a midsection between the first and second ends, the midsection configured for positioning within the cooking exhaust vent along a conducting surface of a cooking exhaust vent; and
a module configured for positioning outside the cooking exhaust vent, the module having a signal source connected to the first end of the conductor for transmitting a signal at the first end of the conductor, a receiver connected to the second end of the conductor for receiving the signal at the second end of the conductor, and a timer circuit for measuring a time between transmission of the signal at the first end and reception of the signal at the second end, wherein the time indicates the amount of grease deposit in the cooking exhaust vent.

4. The device of claim 3, wherein the electronics module is configured to determine the amount of grease deposit based on a comparison between the measured time and an expected signal time delay when the cooking exhaust vent has no grease.

5. The device of claim 3, wherein the midsection of the conductor is configured for positioning along the conducting surface of the cooking exhaust vent without contacting the conducting surface.

6. The device of claim 3, wherein the midsection of the conductor is configured for positioning along the conducting surface of the cooking exhaust vent substantially parallel to the conducting surface.

7. The device of claim 3, further comprising one or more insulating tabs for positioning between the midsection of the conductor and the conducting surface to prevent contact between the conductor and the conducting surface.

8. The device of claim 3, wherein the midsection of the conductor forms a loop such that the first and second ends of the conductor are adjacent to each other.

9. The device of claim 3, further comprising a second conductor extending parallel to the conductor to form a differential pair with the conductor.
